(19) United States
(12) Patent Application Publication
(10) Pub. No.: US 2016/0079640 A1
(43) Pub. Date: Mar. 17, 2016

(54) WATER-COOLED BATTERY MODULE AND WATER-COOLED BATTERY COOLING APPARATUS USING THE SAME

(71) Applicant: HYUNDAI MOBIS Co., Ltd, Seoul (KR)

(72) Inventor: Yong Jung KIM, Yongin-si (KR)

(73) Assignee: HYUNDAI MOBIS Co., Ltd, Seoul (KR)

(21) Appl. No.: 14/743,121

(22) Filed: Jun. 18, 2015

(30) Foreign Application Priority Data
Sep. 11, 2014 (KR) 10-2014-0120261

(51) Int. Cl. H01M 10/6567; H01M 10/625

(52) U.S. Cl. CPC H01M 10/6567; H01M 10/625; H01M 2220/20

(57) ABSTRACT

Provided are a water-cooled battery module and a water-cooled battery cooling apparatus using the same. The water-cooled battery module includes a plurality of stacked battery cells, and a cooling unit installed in the plurality of battery cells and configured to cool the plurality of battery cells. The cooling unit includes an inlet pipe to which a coolant is introduced, an outlet pipe spaced apart from the inlet pipe and configured to discharge the coolant introduced from the inlet pipe, and cooling channel units configured to connect the inlet pipe and the outlet pipe and accommodate the coolant introduced from the inlet pipe therein to dissipate heat generated by the plurality of battery cells. The cooling channel units are disposed to be parallel between the plurality of battery cells and disposed to be in surface-contact with the plurality of battery cells.

### CROSS-REFERENCE TO RELATED APPLICATIONS

This application claims priority under 35 U.S.C. §119 to Korean Patent Application No. 10-2014-0120261, filed on Sep. 11, 2014, the disclosure of which is incorporated herein by reference in its entirety.

### TECHNICAL FIELD

The present invention relates to a water-cooled battery cooling apparatus, and more particularly, to a water-cooled battery module and a water-cooled battery cooling apparatus using the same.

### BACKGROUND

Recently, with the interest in protection of the environment increasing, vehicles other than existing vehicles using combustion-type engines, that is, hybrid vehicles or fuel cell vehicles, have been actively developed.

Hybrid vehicles are driven with two types of power sources by linking an existing engine and a motor driven with electric energy, having effects of reducing environmental pollution due to an exhaust gas and enhancing fuel efficiency, and, as such, hybrid vehicles have been settled as reality-alternative next-generation vehicles lately spotlighted in the United States and Japan.

In general, as power sources of hybrid vehicles, an engine driven with gasoline and diesel and a motor as an auxiliary power source are used.

That is, when driven at a low speed, a hybrid vehicle runs using a motor as power source, and at a speed equal to or higher than a predetermined speed, the hybrid vehicle runs by switching a power source to an engine.

A battery is used as a power source required for driving the motor, and such a battery acts as a key factor in lifespan of an electric vehicle as well as in a hybrid vehicle.

Thus, in order to effectively operate a battery, the battery should be thoroughly managed.

In particular, unlike a primary battery unavailable to be recharged, a rechargeable battery that can be charged and discharged is commonly used as a power source for driving a motor of a hybrid vehicle and an electric vehicle.

A small capacity rechargeable battery may be used in a small portable electric device such as a cellular phone, a notebook computer, and a camcorder.

When a related art battery is used for a long period of time, heat is generated from the battery, and in particular, a large capacity battery generates a larger amount of heat as an amount of current increases when they battery is charged or discharged. If the generated heat is not properly removed, the battery may be degraded in performance or, further, ignited or exploded.

In order to maintain or enhance battery performance, a battery is to be essentially cooled, and an existing battery cooling apparatus largely employs an air cooling scheme.

However, the air cooling scheme has a problem in that air heated in the entrance flows to the rear side structurally according to an installation position of a cooling fan, failing to uniformly cool a battery. In addition, the air cooling scheme has a limitation in application to a large capacity battery in that air having low heat conductivity is used.

Thus, recently, in order to overcome the limitation of the air cooling scheme, a water-cooled cooling apparatus has been actively researched

Korean Patent Laid Open Publication No. 10-2013-0062056 discloses a water-cooled cooling apparatus. Referring to FIG. 1 of this document, the water-cooled cooling apparatus includes a plurality of battery cells 10 formed to be parallel and spaced apart from one another by a predetermined distance, heat dissipation plates 20 interposed and tightly attached between the battery cells 10 and provided to be wider than an electrode assembly 11 of each battery cell 100, an entrance manifold 30 connected to inlets 22 of cooling pipes 21 and having an inlet pipe 31 formed on one side thereof, and an exit manifold 40 connected to outlets 23 of the cooling pipes 21 and having an outlet pipe 41 formed on one side thereof.

In the related art water-cooled cooling apparatus, since the cooling pipes 21 are integratedly formed in the edge portions of the heat dissipation plates 20 interposed and tightly attached between the plurality of battery cells 10 stacked to be parallel, heat conductivity of portions where the heat dissipation plates 20 and the cooling pipes 21 are in contact is enhanced, increasing cooling efficiency of the battery cells 10.

However, in the water-cooled cooling apparatus, since the cooling pipes 21 are disposed in the circumferences of the battery cells 10, the area in which the cooling pipes 21 and the battery cells 10 are in contact is small.

Thus, since the cooling pipes 21 and the battery cells 10 are in contact with each other in the small areas of the circumferences, there is a limitation in effectively cooling the battery cells 10, and in particular, it is difficult to effectively cool even the planar portions of the battery cells 10 which are not in contact with the cooling pipes 21.

### SUMMARY

Accordingly, the present invention provides a water-cooled battery module capable of enhancing cooling efficiency of a battery cell by increasing an area in which the battery cell and a cooling device are in contact, and a water-cooled battery cooling apparatus using the same.

In one general aspect, a water-cooled battery module includes: a plurality of stacked battery cells; and a cooling unit installed in the plurality of battery cells and configured to cool the plurality of battery cells, wherein the cooling unit includes an inlet pipe to which a coolant is introduced; an outlet pipe spaced apart from the inlet pipe and configured to discharge the coolant introduced from the inlet pipe; and a plurality of cooling channel units configured to connect the inlet pipe and the outlet pipe and accommodate the coolant introduced from the inlet pipe therein to dissipate heat generated by the plurality of battery cells, wherein the cooling channel units are disposed to be parallel between the plurality of battery cells and disposed to be in surface-contact with the plurality of battery cells.

The cooling channel units may include linear channel portions formed to have a shape of a plurality of plates and disposed to be parallel between the plurality of battery cells; and curved channel portions having a curved shape and configured to connect the linear channel portions spaced apart from one another in outer edges of the plurality of battery cells.

The linear channel portions may be coupled to the inlet pipe or the outlet pipe.

A flow channel guide portion guiding a flow of a coolant may be formed within the cooling channel units, and a plurality of flow channel guide portions may be spaced apart from one another to form coolant flow channels.

One ends of the inlet pipe and the outlet pipe may be hermetically closed and the other ends thereof may communicate with the exterior, and an inlet coupling portion may protrude from an outer circumferential surface of the inlet pipe and allow any one of the linear channel portions to be coupled thereto to allow a coolant to be introduced to the cooling channel units therethrough, and an outlet coupling portion may protrude from an outer circumferential surface of the outlet pipe to allow another linear channel portion to be coupled thereto to allow a coolant from the cooling channel units to be discharged therethrough.

The water-cooled battery module may further include a housing configured to have an accommodation space therein and cover the plurality of battery cells and the cooling unit.

The housing may include an upper housing disposed above the plurality of battery cells and a lower housing disposed below the plurality of battery cells and coupled to the upper housing.

In another general aspect, a water-cooled battery cooling apparatus includes: a water-cooled battery module including a first water-cooled battery module and a second water-cooled battery module disposed to be parallel to the first water-cooled battery module; a coupling member configured to couple the first water-cooled battery module and the second water-cooled battery module; an inlet manifold configured to allow a coolant to be introduced to the water-cooled battery module; and an outlet manifold spaced apart from the inlet manifold and configured to discharge the coolant from the water-cooled battery module, wherein the water-cooled battery module includes: a plurality of stacked battery cells; and a cooling unit installed in the plurality of battery cells and configured to cool the plurality of battery cells, wherein the cooling unit includes an inlet pipe to which a coolant is introduced; an outlet pipe spaced apart from the inlet pipe and configured to discharge the coolant introduced from the inlet pipe; and cooling channel units configured to connect the inlet pipe and the outlet pipe and accommodate the coolant introduced from the inlet pipe therein to dissipate heat generated by the plurality of battery cells, wherein the cooling channel units are disposed to be parallel between the plurality of battery cells and disposed to be in surface-contact with the plurality of battery cells.

One surface of the first water-cooled battery module and the other surface of the second water-cooled battery module may be in surface-contact with each other, and the coupling member may include: a pair of end plates in surface-contact with the other surface of the first water-cooled battery module and one surface of the second water-cooled battery module; and fixing members configured to connect the pair of end plates to tightly fix the first water-cooled battery module and the second water-cooled battery module.

Other features and aspects will be apparent from the following detailed description, the drawings, and the claims.

### BRIEF DESCRIPTION OF THE DRAWINGS

FIG. 1 is an exploded perspective view illustrating a related art battery cooling apparatus.

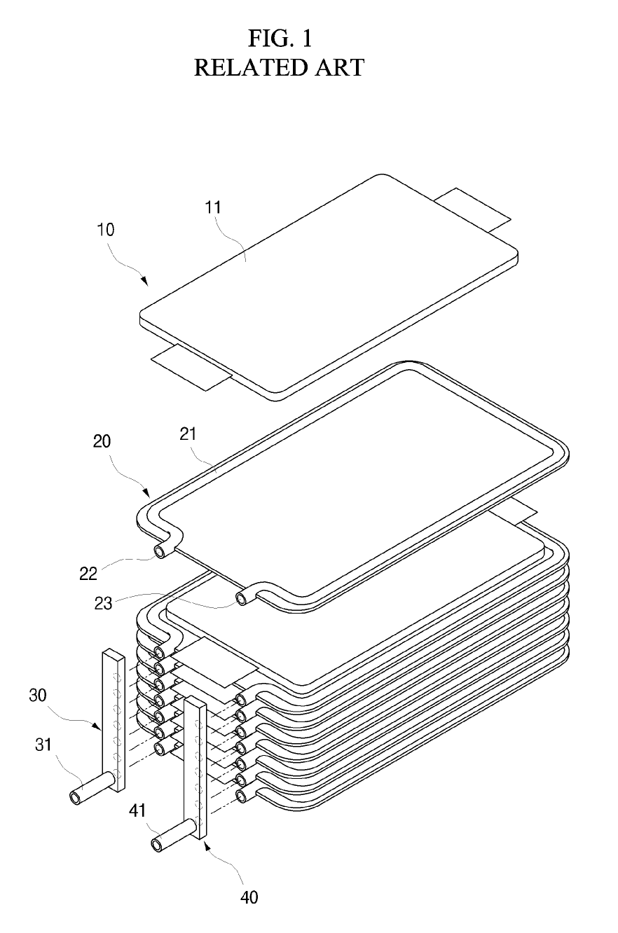

FIG. 2 is a perspective view illustrating a water-cooled battery module according to an embodiment of the present invention.

FIG. 3 is an exploded perspective view illustrating a water-cooled battery module.

FIG. 4 is a perspective view illustrating a cooling unit of a water-cooled battery module according to an embodiment of the present invention.

FIG. 5 is a cross-sectional view taken along line A-A′ of FIG. 4.

FIG. 6 is a cross-sectional view taken along line B-B′ of FIG. 4.

FIG. 7 is a bottom perspective view illustrating a flow channel guide portion of a cooling panel unit according to an embodiment of the present invention.

FIG. 8 is a perspective view illustrating a water-cooled battery cooling apparatus according to an embodiment of the present invention.

FIG. 9 is a side view illustrating a water-cooled battery cooling apparatus according to an embodiment of the present invention.

FIG. 10 is an exploded perspective view illustrating a water-cooled battery cooling apparatus according to an embodiment of the present invention.

### DETAILED DESCRIPTION OF EMBODIMENTS

Hereinafter, embodiments of the present invention will be described in detail with reference to the accompanying drawings.

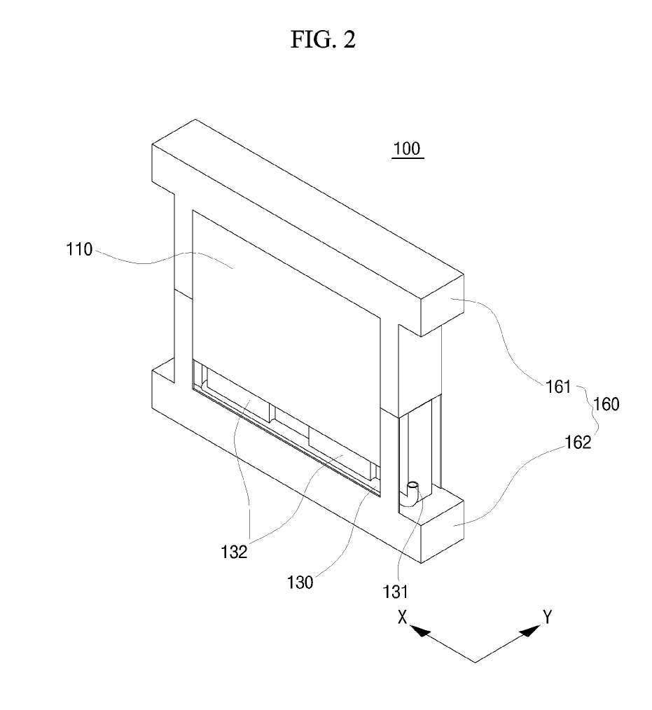

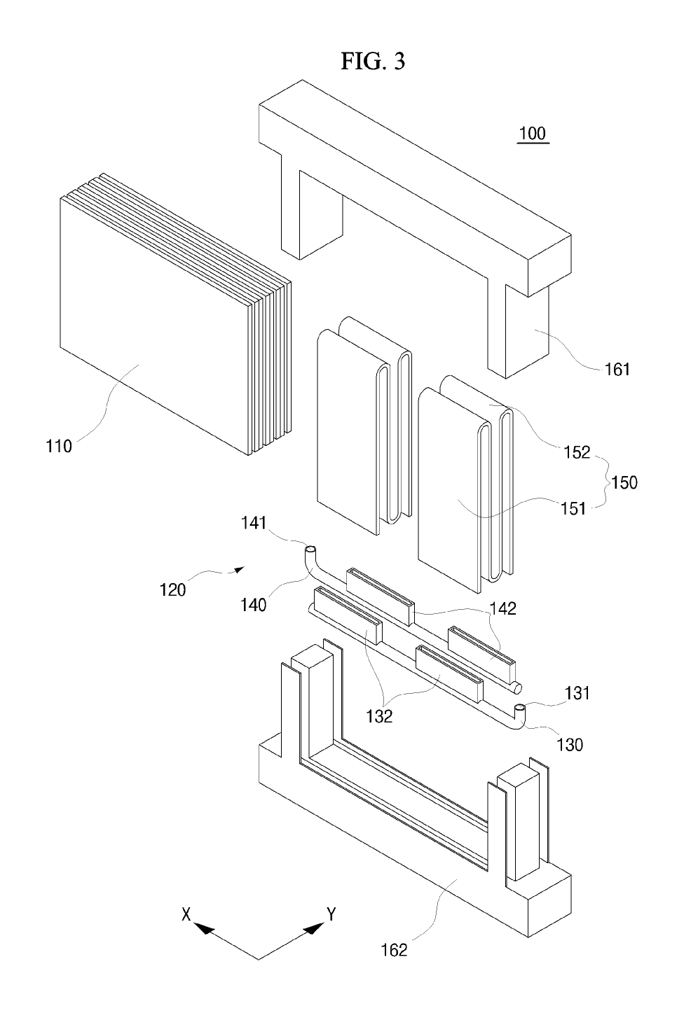

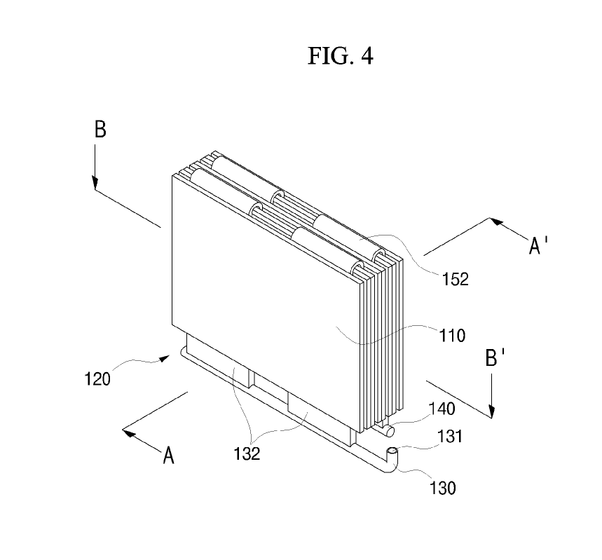

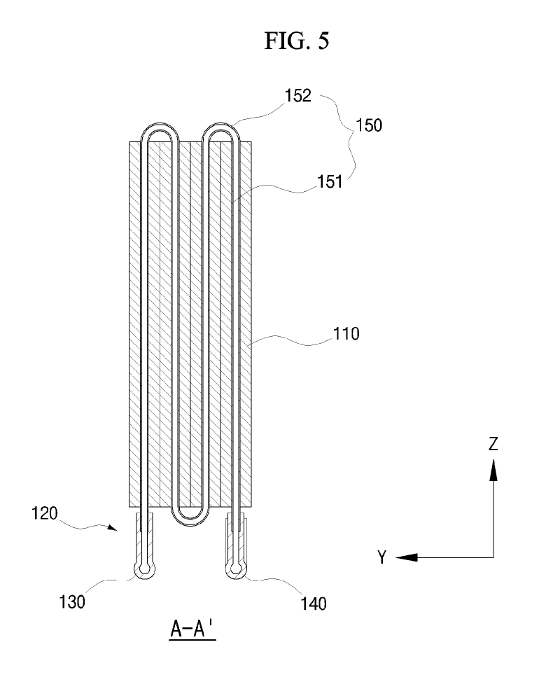

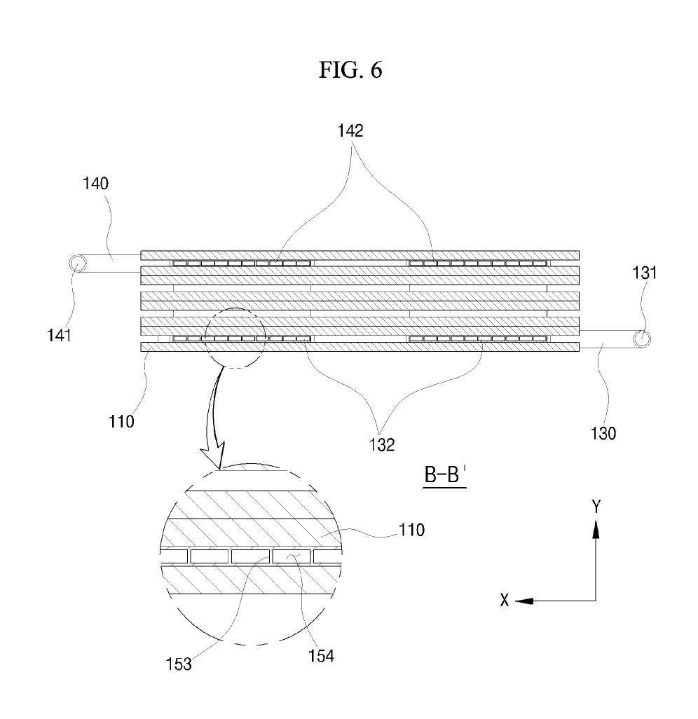

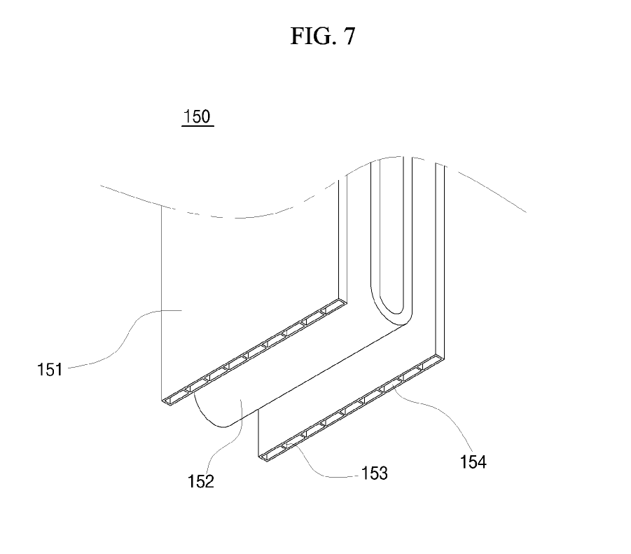

FIG. 2 is a perspective view illustrating a water-cooled battery module according to an embodiment of the present invention, FIG. 3 is an exploded perspective view illustrating a water-cooled battery module, FIG. 4 is a perspective view illustrating a cooling unit of a water-cooled battery module according to an embodiment of the present invention, FIG. 5 is a cross-sectional view taken along line A-A′ of FIG. 4, FIG. 6 is a cross-sectional view taken along line B-B′ of FIG. 4, and FIG. 7 is a bottom perspective view illustrating a flow channel guide portion of a cooling panel unit according to an embodiment of the present invention.

As illustrated in FIGS. 2 through 7, the water-cooled battery module 100 according to an embodiment of the present invention includes a plurality of battery cells 110, a cooling unit 120, and a housing 160.

The battery cells 110 have a plate shape and are stacked in one direction, and here, the battery cells 110 are stacked such that mutually adjacent surfaces thereof face each other.

Some of the battery cells 110 are disposed to be spaced apart from one another, while the others thereof are in surface-contact with each other.

Thus, the cooling unit may be easily disposed between the separated battery cells 110.

The cooling unit 120 is installed in the plurality of battery cells 110 to cool heat of the battery cells 110 generated according to a current amount when a charging or discharging operation is performed. The cooling unit 120 includes an inlet pipe 130, an outlet pipe 140, and cooling channel unit. 150

Preferably, the inlet pipe 130 extends in an X axis direction from a lower portion of the battery cells 110, and one end thereof is hermetically closed and the other thereof has a first inlet 131 communicating with the exterior.

Accordingly, a coolant cooling the battery cells is introduced to the interior of the inlet pipe 130 through the first inlet 131.

The inlet pipe 130 has an inlet coupling portion 132.

The inlet coupling portion 132 protrudes toward the battery cells 110 from an outer circumferential surface of the inlet pipe 130, and preferably, as illustrated in FIGS. 2, 3, and 6, a plurality of inlet coupling portion 132 are spaced apart from one another in the X axis direction and communicate with the interior of the inlet pipe 130.

The inlet coupling portions 132 are coupled with cooling channel units 150 to allow a coolant introduced from the first inlet 131 to flow to the cooling channel unit 150.

The outlet pipe 140 is preferably spaced apart from the inlet pipe 130 from a lower portion of the battery cells 110 and extends in the X axis direction as illustrated in FIGS. 2 and 3. One end of the outlet pipe 140 is hermetically closed and the other end thereof has a first outlet 141 communicating with the exterior.

Accordingly, a coolant introduced from the inlet pipe 130 is discharged to the outside of the outlet pipe 140 through the first outlet 141.

The outlet pipe 140 has an outlet coupling portion 142.

The outlet coupling portion 142 protrudes from an outer circumferential surface of the outlet pipe 140 toward the battery cells 110, and preferably, a plurality of outlet coupling portions 142 are spaced apart from one another in the X axis direction illustrated in FIGS. 2, 3, and 6, and communicate with the interior of the outlet pipe 140.

The outlet coupling portions 142 are coupled to the cooling channel units 150 to discharge a coolant of the cooling channel units 150 to the interior of the outlet pipe 140.

The cooling channel units 160 absorb heat from the battery cells 110 generated during a charging or discharging operation, and the battery cells 110 are slidably coupled to the cooling channel units 150 in the X-axis direction illustrated in FIGS. 2 and 3.

The inlet coupling portions 132 of the inlet pipe 130 are coupled to one ends of the cooling channel units 150, and the outlet coupling portions 142 of the outlet pipe 140 are coupled to the other ends of the cooling channel unit 150, whereby the inlet pipe 130 and the outlet pipe 140 are connected to each other.

To this end, the number of the cooling channel units 150 may correspond to the plurality of inlet coupling portions 132 and the plurality of outlet coupling portions 142 may be provided.

As described above, the plurality of cooling channel units 150 are disposed to be parallel and in surface-contact with the battery cells 110 between the battery cells 110 spaced apart from one another.

Also, a coolant introduced from the inlet pipe 130 is accommodated within the cooling channel units 150.

Thus, since the cooling channel unit 150 accommodating the coolant is in surface-contact with the battery cells 110, heat generated when the battery cells 110 are charged or discharged may be effectively cooled.

Here, the cooling channel units 150 may be formed of a material having excellent heat conductivity such as an aluminum alloy or copper capable of effectively absorb heat generated by the battery cells 110.

The cooling channel units 150 include a linear channel portion 151, a curved channel portion 152, and a flow channel guide portion 153.

The linear channel portions 151 are formed to have a shape of a plurality of plates and disposed to be parallel between the battery cells 110 disposed to be spaced apart from one another. As illustrated in FIG. 4, one end of any one of the plurality of linear channel portions 151 is coupled to the inlet coupling portion 132 and one end of the other is coupled to the outlet coupling portion 142.

To this end, a cross-sectional area of the linear channel portion 151 is formed to be equal to cross-sectional areas of the inlet coupling portion 132 and the outlet coupling portion 142.

Accordingly, the cooling channel units 150 may be easily coupled to the inlet coupling portions 132 and the outlet coupling portions 142, and a coolant introduced from the inlet coupling portions 132 may pass through the cooling channel units 150 and easily discharged to the outlet coupling portions 142.

Here, two or fewer battery cells 110 may be disposed between the linear channel portions 151.

If three or more battery cells 110 are disposed between two linear channel portions 151, two battery cells 110 may be in surface-contact with the two linear channel portions 151, respectively, and a battery cell 110 may be disposed not in contact with the linear channel portions 151 between the two battery cells 110 in surface-contact with the linear channel portions, respectively.

In this case, since the battery cell 110 disposed between the two battery cells in surface-contact with the linear channel portions 151, respectively, does not directly in contact with the linear channel portions 151, cooling efficiency thereof is degraded.

Thus, in order to enhance cooling efficiency of the battery cells 110, preferably, two or fewer battery cells are disposed between the two linear channel portions 151 as described above.

The curved channel portions 152 may have a curved shape in outer edges of the battery cells 110, and connect the linear channel portions 151 spaced apart from one another.

Although not shown, when two linear channel portions 151 are provided, the curved channel portions are disposed in the other ends, the opposite direction of one ends of the linear channel portions 151 coupled to the inlet coupling portions 132 and the outlet coupling portions 142.

As illustrated in FIGS. 4 and 5, when the plurality of linear channel portions 151 are provided, the curved channel portions 152 may be disposed to intersect in zigzag manner from the other ends of the linear channel portions 151.

Thus, a coolant may be evenly accommodated in the cooling channel portions 150, increasing cooling efficiency of the battery cells 110.

The flow channel guide portion 153 is a partition disposed within the cooling channel units 150. As illustrated in FIGS. 6 and 7, a plurality of flow channel guide portions 153 are formed to be spaced apart from one another to form a coolant flow channel 154 allowing a coolant to flow therein.

The flow channel guide portions 153 are formed to traverse from the interior of the linear channel portions 151 to the curved channel portions 152.

Thus, a coolant flows along the flow channel guide portions disposed between the battery cells 110 and disposed to be in surface-contact with the battery cells 110, absorbing heat generated when the battery cells 110 are charged or discharged.

Thus, preferably, the flow channel guide portions 153 according to an embodiment of the present invention are designed to have optimal cooling efficiency.

Here, it is illustrated in the drawings that the plurality of inlet coupling portions 132, the plurality of outlet coupling portions 142, and the plurality of cooling channel portions 150 are provided, but one inlet coupling portions 132, one outlet coupling portions 142, and one cooling channel portion 150 may be provided and the length of the cross-sectional area in the X axis direction illustrated in FIGS. 2 and 3 is close to the lengths of the inlet pipe 130 and the outlet pipe 140 as long as the cooling channel units 150 are easily connected to the inlet pipe 130 and the outlet pipe 140 and the battery cells 110 are effectively cooled.

Thus, since the area of the linear channel portions 151 in surface-contact with the battery cells 110 is closed to the area of the battery cells 110, a coolant flowing within the linear channel portions 151 along the flow channel guide portions 163 may be evenly in contact with the battery cells 110, effectively absorbing heat generated when the battery cells 110 are charged or discharged.

The housing 160 may be may have an accommodation space formed therein to cover the battery cells 110 and the cooling unit 120, and includes an upper housing 161 and a lower housing 162.

The upper housing 161 is disposed above the battery cells 110 and covers an upper portion and a partial side portion of the battery cells 110 and the lower housing 162 may be disposed below the battery cells 110 to cover a lower portion and the other remaining side portion of the battery cells 110.

Accordingly, the housing 160 may easily protect the battery cells 110 and cooling unit 120 against an external force.

Here, preferably, the upper housing 161 and the lower housing 162 are disposed above and below the battery cells 110 and slidably coupled to the battery cells 110, but the present invention is not limited thereto. The upper housing 161 and the lower housing 162 may be coupled in various manners.

Here, as illustrated in FIG. 7, a single water-cooled battery module 100 may be provided, but the present invention is not limited thereto and a plurality of water-cooled battery modules 100 may be provided according to sizes and specifications of vehicles and assembled to each other.

Hereinafter, a water-cooled battery cooling apparatus including a plurality of water-cooled battery modules 100 will be described in detail with reference to the accompanying drawings.

In describing the water-cooled battery modules 100, descriptions of the same components as those of the water-cooled battery module 100 described above will be omitted in order not to obscure the gist of the present invention.

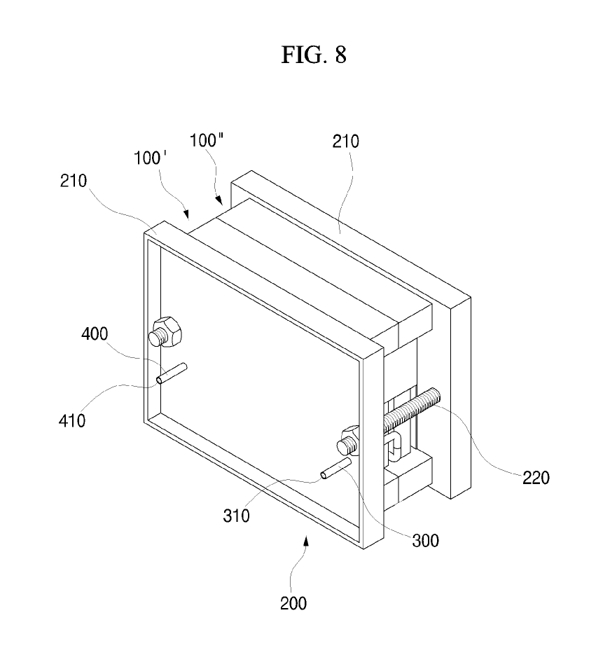

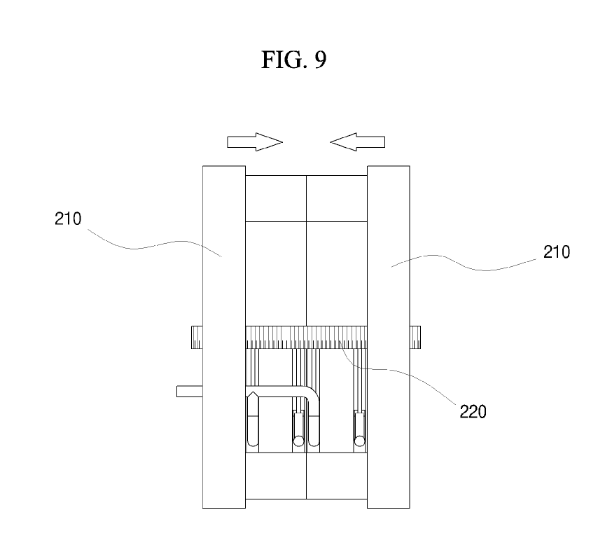

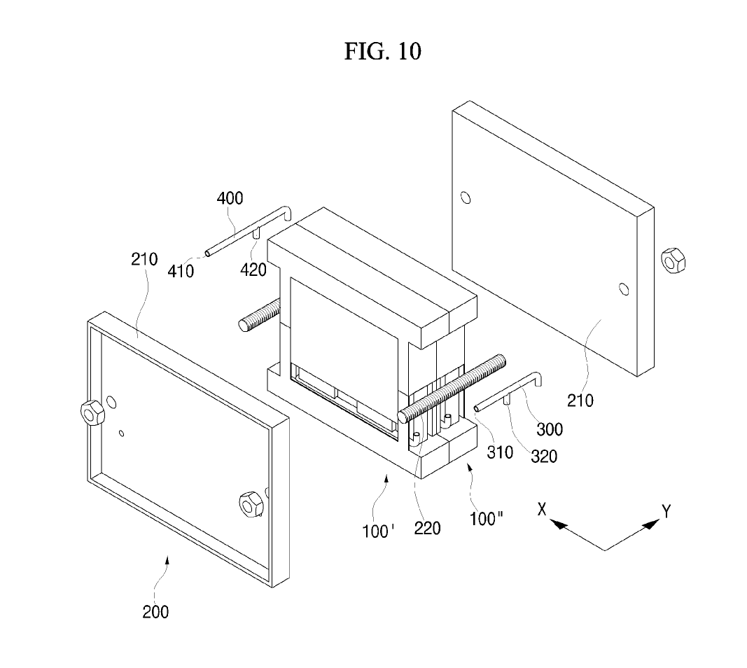

FIG. 8 is a perspective view illustrating a water-cooled battery cooling apparatus according to an embodiment of the present invention, FIG. 9 is a side view illustrating a water-cooled battery cooling apparatus according to an embodiment of the present invention, and FIG. 10 is an exploded perspective view illustrating a water-cooled battery cooling apparatus according to an embodiment of the present invention.

Referring to FIGS. 8 through 10, a water-cooled battery cooling apparatus according to an embodiment of the present invention preferably has a structure installed within a vehicle, including a plurality of water-cooled battery modules 100, a coupling member 200, an inlet manifold 300, and an outlet manifold 400.

The water-cooled battery modules 100 includes a first water-cooled battery module 100′ and a second water-cooled battery module 100″, and the first water-cooled battery module 100′ and the second water-cooled battery module 100″ are disposed to be parallel to each other.

In detail, as illustrated in FIG. 8, one surface of the first water-cooled battery module 100′ and the other surface of the second water-cooled battery module 100″ are in surface-contact with each other.

Here, the number of the first water-cooled battery module 100′ and the number of the second water-cooled battery module 100″ are not limited and a plurality of first water-cooled battery module 100′ and a plurality of second water-cooled battery module 100″ may be stacked to be disposed according to sizes and specifications of vehicles.

However, hereinafter, in order to help understand the water-cooled battery cooling apparatus according to an embodiment of the present invention, it is described that the water-cooled battery module 100 includes the first water-cooled battery module 100′ and the second water-cooled battery module 100″.

Also, the configurations of the first water-cooled battery module 100′ and the second water-cooled battery module 100″ are the same as that of the water-cooled battery module 100, and thus, detailed descriptions thereof will be omitted in order not to obscure the gist of the present invention.

The coupling member 200 couples the first water-cooled battery module 100′ and the second water-cooled battery module 100″ and includes end plates 210 and fixing members 220.

The end plates 210 are formed as a pair, and the water-cooled battery module 100 is disposed between the pair of end plates 210.

In detail, any one of the pair of end plates 210 is in surface-contact with the other surface of the first water-cooled battery module 100′, and the other of the pair of end plates 210 is in surface-contact with one surface of the second water-cooled battery module 100″.

Accordingly, the pair of end plates 210 may be disposed in both ends of the water-cooled battery module 100 in which the first water-cooled battery module 100′ and the second water-cooled battery module 100″ are stacked, supporting the water-cooled battery module 100 in an inward direction.

The fixing members 220 connect the pair of end plates 210 to support the first water-cooled battery module 100′ and the second water-cooled battery module 100″ disposed between the pair of end plates 210 in the inward direction, thereby firmly fixing the first water-cooled battery module 100′ and the second water-cooled battery module 100″.

Accordingly, as illustrated in FIG. 9, first water-cooled battery module 100′ and the second water-cooled battery module 100″ may be easily compressed and fixed such that the plurality of battery cells 110 may not extend further in a horizontal direction according to expansion and contraction.

Here, the end plates 210 and the fixing members 220 may be fastened by a member such as a bolt or a nut.

As illustrated in FIG. 10, the inlet manifold 300 serves to distribute a coolant introduced from the outside to the plurality of inlet coupling portions 132. The inlet manifold 300 extends in the Y axis direction from a position where the first inlet 131 of the inlet pipe 130 is formed, and has one end which is hermetically closed and the other end which has a second inlet 310 communicating with the exterior.

A coolant for cooling the battery cells 110 is introduced through the second inlet 310.

The inlet pipe 130 has an inflow pipe 320.

A plurality of inflow pipes 320 corresponding to the inlet coupling portions 132 protrude from an outer circumferential surface of the inlet manifold 300.

The inflow pipes 320 communicates with the interior of the inlet manifold 300 and are coupled to the inlet coupling portions 132 to allow a coolant introduced from the second inlet 310 to flow in to the inlet pipe 130.

As illustrated in FIG. 10, the outlet manifold 400 receives a coolant discharged from the plurality of outlet coupling portions 142 and discharges the coolant through a single pipe. Preferably, the outlet manifold 400, spaced apart from the inlet manifold 300, extends in the Y axis direction from a position where the first outlet 141 of the outlet pipe 140 is formed, and has one end which is hermetically closed and the other end which has a second inlet 410 communicating with the exterior.

A coolant introduced from the cooling channel unit 150 is discharged to the outside through the second outlet 410.

The outlet manifold 400 has an outlet pipe 420.

A plurality of outlet pipes 420 corresponding to the outlet coupling portions 142 protrude from an outer circumferential surface of the outlet manifold 400.

The outlet pipe 420 communicates with the interior of the outlet manifold 400 and is coupled to the outlet coupling portion 142 to discharge a coolant introduced from the outlet coupling portion 142 to the interior of the outlet manifold 400.

Here, the second inlet 310 of the outlet pipe 140 and the second outlet 410 of the inlet pipe 130 may be disposed in the same position, but as illustrated in FIGS. 8 and 10, preferably, the other end of the inlet pipe 130 and the other end of the outlet pipe 140 are disposed in the mutually opposite direction.

Thus, the inlet manifold 300 coupled to the first inlet 131 of the inlet pipe 130 and the outlet manifold 400 coupled to the first outlet 141 of the outlet pipe 140 are restrained from being disposed in an overlapping position, and a disposition structure of the inlet manifold 300 and the outlet manifold 400 is restrained from being complicated.

As described above, in the water-cooled battery cooling apparatus according to an embodiment of the present invention, since the cooling channel units 150 are disposed to be parallel between the battery cells 110 and are disposed to be in surface-contact with the battery cells 110, the cooling channel units 150 may effectively absorb heat generated by the battery cells 110.

Thus, lifespan of the battery module may lengthen.

Also, since the inlet coupling portions 132 are formed in the inlet pipe 130 and the outlet coupling portions 142 are formed on the outlet pipe 140, a coolant may be easily introduced to the cooling channel units 150 through the inlet coupling portions 132, and the coolant may be easily discharged from the cooling channel units 150 through the outlet coupling portions 142.

Also, since the coupling member 200 includes a pair of end plates 210 in surface-contact with the first water-cooled battery module 100′ and the second water-cooled battery module 100″ and the fixing members 220 connecting the pair of end plates 210, the first water-cooled battery module 100′ and the second water-cooled battery module 100″ may be easily fixed by coupling the pair of end plates 210 and the fixing members 220.

Without being limited to the foregoing embodiments, the present invention may be variously modified within the scope of the technical concept of the present invention.

According to embodiments of the present invention, since the cooling channel units are disposed to be parallel between the plurality of battery cells and disposed to be in surface-contact with the plurality of battery cells, an area in which the cooling channel units are in contact with the battery cells increases, effectively absorbing heat generated by the battery cells.

Thus, lifespan of the battery module may lengthen.

Since the cooling channel units have the linear channel portions disposed to be parallel to each other between the battery cells and the curved channel portions connecting the linear channel portions, heat generated by the battery cell s may be effectively absorbed by the linear channel portions disposed to be parallel to each other between the battery cells.

Since the flow channel guide portions guiding a flow of a coolant are provided within the cooling channel units, a coolant within the cooling channel units may evenly flow along the flow channel guide portions.

Since the inlet coupling portions protrude from the inlet pipe and the outlet coupling portions protrude from the outlet pipe, a coolant may be easily introduced to the cooling channel units through the inlet coupling portions and the coolant may be easily discharged from the cooling channel portions through the outlet coupling portions.

Since the upper housing is disposed above the battery cells and the lower housing is disposed below the battery cells, the battery cells and the cooling unit may be easily protected.

Since the coupling member includes the pair of end plates in surface-contact with the first water-cooled battery module and the second water-cooled battery module and the fixing members connecting the pair of end plates, the first water-cooled battery module and the second water-cooled battery module may be easily fixed by coupling the pair of end plates and the fixing members.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A water-cooled battery module comprising:
a plurality of stacked battery cells; and
a cooling unit installed in the plurality of battery cells and configured to cool the plurality of battery cells,
wherein
the cooling unit comprises:
an inlet pipe to which a coolant is introduced;
an outlet pipe spaced apart from the inlet pipe and configured to discharge the coolant introduced from the inlet pipe; and
a plurality of cooling channel units configured to connect the inlet pipe and the outlet pipe and accommodate the coolant introduced from the inlet pipe therein to dissipate heat generated by the plurality of battery cells, and
the cooling channel units are disposed to be parallel between the plurality of battery cells and disposed to be in surface-contact with the plurality of battery cells.

2. The water-cooled battery module of claim 1, wherein each of the cooling channel units include:
linear channel portions formed to have a shape of a plurality of plates and disposed to be parallel between the plurality of battery cells; and
curved channel portions having a curved shape and configured to connect the linear channel portions spaced apart from one another in outer edges of the plurality of battery cells.

3. The water-cooled battery module of claim 2, wherein the linear channel portions are coupled to the inlet pipe or the outlet pipe.

4. The water-cooled battery module of claim 2, wherein a flow channel guide portion guiding a flow of a coolant is formed within the cooling channel units, and
a plurality of flow channel guide portions are spaced apart from one another to form coolant flow channels.

5. The water-cooled battery module of claim 3, wherein one ends of the inlet pipe and the outlet pipe are hermetically closed and the other ends thereof communicate with the exterior, and
an inlet coupling portion protrudes from an outer circumferential surface of the inlet pipe and allows any one of the linear channel portions to be coupled thereto to allow a coolant to be introduced to the cooling channel units therethrough, and
an outlet coupling portion protrudes from an outer circumferential surface of the outlet pipe and allows another linear channel portion to be coupled thereto to allow a coolant from the cooling channel units to be discharged therethrough.

6. The water-cooled battery module of claim 1, further comprising:
a housing configured to have an accommodation space therein and cover the plurality of battery cells and the cooling unit.

7. The water-cooled battery module of claim 6, wherein the housing includes:
an upper housing disposed above the plurality of battery cells; and
a lower housing disposed below the plurality of battery cells and coupled to the upper housing.

8. A water-cooled battery cooling apparatus comprising:
a water-cooled battery module including a first water-cooled battery module and a second water-cooled battery module disposed to be parallel to the first water-cooled battery module;
a coupling member configured to couple the first water-cooled battery module and the second water-cooled battery module;
an inlet manifold configured to allow a coolant to be introduced to the water-cooled battery module; and
an outlet manifold spaced apart from the inlet manifold and configured to discharge the coolant from the water-cooled battery module,
wherein
the water-cooled battery module comprises:
a plurality of stacked battery cells; and
a cooling unit installed in the plurality of battery cells and configured to cool the plurality of battery cells,
the cooling unit comprises:
includes an inlet pipe to which a coolant is introduced;
an outlet pipe spaced apart from the inlet pipe and configured to discharge the coolant introduced from the inlet pipe; and
a plurality of cooling channel units configured to connect the inlet pipe and the outlet pipe and accommodate the coolant introduced from the inlet pipe therein to dissipate heat generated by the plurality of battery cells, and
the cooling channel units are disposed to be parallel between the plurality of battery cells and disposed to be in surface-contact with the plurality of battery cells.

9. The water-cooled battery cooling apparatus of claim 8, wherein each of the cooling channel units comprises:
a plurality of linear channel portions formed to have a shape of a plurality of plates and disposed to be parallel between the plurality of battery cells; and
a plurality of curved channel portions having a curved shape and configured to connect the linear channel portions spaced apart from one another in outer edges of the plurality of battery cells.

10. The water-cooled battery cooling apparatus of claim 9, wherein the linear channel portions are coupled to the inlet pipe or the outlet pipe.

11. The water-cooled battery cooling apparatus of claim 9, wherein
a flow channel guide portion guiding a flow of a coolant is formed within the cooling channel units, and
a plurality of flow channel guide portions may be spaced apart from one another to form coolant flow channels.

12. The water-cooled battery cooling apparatus of claim 10, wherein
one ends of the inlet pipe and the outlet pipe are hermetically closed and the other ends thereof communicates with the exterior, and
an inlet coupling portion protrudes from an outer circumferential surface of the inlet pipe and allow any one of the linear channel portions to be coupled thereto to allow a coolant to be introduced to the cooling channel units therethrough, and
an outlet coupling portion protrudes from an outer circumferential surface of the outlet pipe to allow another linear channel portion to be coupled thereto to allow a coolant from the cooling channel units to be discharged therethrough.

13. The water-cooled battery cooling apparatus of claim 9, wherein
a plurality of inflow pipes are provided in the inlet manifold and coupled to the other end of the inlet pipe to allow a coolant to be introduced to the inlet pipe, and
a plurality of outlet pipes are provided in the outlet manifold and coupled to the other end of the outlet pipe to allow the coolant from the water-cooled battery module to be discharged therethrough.

14. The water-cooled battery cooling apparatus of claim 8, wherein the water-cooled battery module further comprises:
a housing configured to have an accommodation space therein and cover the plurality of battery cells and the cooling unit.

15. The water-cooled battery cooling apparatus of claim 14, wherein the housing comprises:
an upper housing disposed above the plurality of battery cells; and
a lower housing disposed below the plurality of battery cells and coupled to the upper housing.

16. The water-cooled battery cooling apparatus of claim 15, wherein
one surface of the first water-cooled battery module and the other surface of the second water-cooled battery module are in surface-contact with each other, and
the coupling member comprises:
a pair of end plates in surface-contact with the other surface of the first water-cooled battery module and one surface of the second water-cooled battery module; and
fixing members configured to connect the pair of end plates to tightly fix the first water-cooled battery module and the second water-cooled battery module.
